(19) United States
(12) Patent Application Publication
(10) Pub. No.: US 2003/0215000 A1
(43) Pub. Date: Nov. 20, 2003

(54) Pseudo-random bit mapping for multitone transceivers

(76) Inventor: Carl C. Hansen, Aloha, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/152,185

(22) Filed: May 20, 2002

(51) Int. Cl. H04B 1/69

(52) U.S. Cl. 375/130

(57) ABSTRACT

An apparatus for transmitting data. A pseudo-random mapping order generator generates pseudo-random mapping order that is to be modified according to a predetermined pattern, such as a symbol time. A bit mapper receives the pseudo-random mapping order and maps bits to channels according to the pseudo-random mapping order. The bits are transmitted to a receiver that synchronizes with the transmitter. A pseudo-random mapping order generator at the receiver generates the pseudo-random mapping order generated by the pseudo-random mapping order generator at the transmitter. A de-mapper receives the pseudo-random mapping order and de-maps the bits from the channels according to the pseudo-random mapping order.

### FIELD OF INVENTION

An embodiment of the present invention relates to transmission of digital information. More particularly, an embodiment of the present invention relates to transmitting digital information according to pseudo-random bit loading of channels.

### BACKGROUND

Digital Subscriber Line (DSL) is a technology for transmitting digital information over telephone lines at higher data rates than analog modems. With DSL, a transceiver (e.g., a modem) connected to customer premises equipment (e.g., a personal computer) and a transceiver at a telephone company central office (CO) are connected via telephone lines called twisted pair. The transmitter modulates digital information onto a carrier signal, and the receiver demodulates the carrier signal to retrieve the digital information.

Discrete multi-tone modulation (DMT) is a technique for improving transceiver capacity. With DMT, rather than one signal carrying digital information, the carrier signal is divided into separate components called channels (or carrier frequencies), each of which carries one or more bits of the digital information. Bit loading, i.e., the number of bits each channel can carry, is determined by the quality of each channel, e.g., in FIG. 1a, channel 1 carries three bits, channel 2 carries two bits, channel 3 carries one bit, channel 4 carries three bits, channel 5 carries four bits and channel 6 carries two bits.

The transmitter retrieves bits from a transmit buffer and maps the bits to the channels, e.g., in FIG. 1a the first three bits from the transmit buffer are mapped to channel 1, the next two bits are mapped to channel 2, the next bit to channel 3, the next three bits to channel 4, the next four bits to channel 5 and the next two bits to channel 6. When the transmitter maps all channels with bits, it modulates the carrier signal and transmits the bits to the receiver. The receiver demodulates the carrier signal, de-maps the bits and places them in a receive buffer.

DMT improves demodulation because a large number of channels containing a few bits are demodulated, rather than demodulating one carrier signal containing a large number of bits. However, one drawback with DMT is that during transmission, large transient spikes of noise can interfere with one or more adjacent channels and thus a large number of bits. Noise in a twisted-pair line degrades the carrier signal during transmission, resulting in bit errors (corrupt bits) due to the loss of signal integrity. Corrupt bits reduce the accuracy of the digital information retrieved from a carrier signal during demodulation. Receivers reconstruct corrupt bits by analyzing error-free surrounding bits. However, because bits are sequentially mapped to channels with DMT, noise interfering with a channel and adjacent channels can corrupt a large number of sequential bits. Corruption of a large number of sequential bits degrades receiver performance because the receiver does not have error-free surrounding bits to analyze in reconstructing corrupt bits.

By contrast, corruption of pseudo-randomly spaced, non-adjacent bits degrades receiver performance to a lesser extent than corruption of sequential bits, because corrupt bits occur intermittently over a large number of bits. Consequently, receivers have surrounding error-free bits to analyze in reconstructing corrupt bits.

In order for pseudo-random spacing of bits across channels to occur, a non-sequential channel mapping order is generated. For example, a channel arrangement generated for channels 1-6 in FIG. 1b provides that channel 5 is mapped first, followed by channel 3, channel 6, channel 1, channel 4 and channel 2. Thus, the transmitter maps the first four bits from the receive buffer to channel 5, the next bit to channel 3, the next two bits to channel 6, the next three to channel 1, the next three to channel 4, and the next two to channel 2. As a result, the bits are non-sequential during transmission, so that any noise affecting the channels during transmission is less likely to affect a large number of sequential bits than when the bits are sequentially mapped.

A transmitting transceiver synchronizes with a receiving transceiver, so that they utilize the same channel mapping order. As a result, the receiving transceiver de-maps bits from the channels in the order in which the transmitting transceiver maps bits to the channels. For example, in FIG. 1b, bits 1-4 are unmapped from channel 5, bit 5 is unmapped from channel 3, bits 6-7 are unmapped from channel 6, bits 8-10 are unmapped from channel 1, bits 11-13 are unmapped from channel 4 and bits 14-15 are unmapped from channel 2.

Current implementations utilize a static sequential or non-sequential channel mapping order, meaning that once the channel mapping order is generated, no adjustments in the channel mapping order are made for changes in environmental and noise conditions. Changes in environmental and noise conditions may eventually reduce the effectiveness of the demodulation and error correction processes, resulting in a loss of channel capacity and a need to recalculate the non-sequential channel mapping order. Recalculating the channel mapping order based on changes in environmental and noise conditions increases a transceiver's complexity and power consumption, and may cause loss of data during the recalculation process, e.g., if the transceiver resets.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1a and FIG. 1b are block diagrams of illustrations of bits mapped to channels;

FIG. 2 is a block diagram of an example communication system within which embodiments of the present invention may be practiced;

FIG. 3 is a block diagram of an example of one embodiment of channel mapping order generators in accordance with the teachings of an embodiment of the present invention;

FIG. 4 is a block diagram of an example of one embodiment of pseudo-random mapping order generators in accordance with the teachings of an embodiment of the present invention; and

FIG. 5a and FIG. 5b are a flow chart of an example method of transmitting data according to a pseudo-random mapping order, in accordance with the teachings of an embodiment of the present invention.

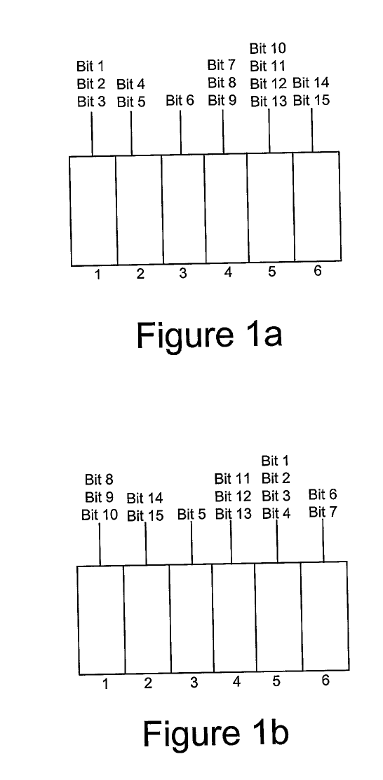

### DETAILED DESCRIPTION

An apparatus and method for transmitting data according to pseudo-random mapping order is described. In the following description, for purposes of explanation, numerous specific details are set forth. It will be apparent, however, to one skilled in the art that embodiments of the invention can be practiced without these specific details. In other instances, structures and devices are shown in block diagram form in order to avoid obscuring the understanding of this description.

A transmitting multicarrier system transceiver (referred to herein as a transmitter) synchronizes with a receiving multicarrier system transceiver (referred to herein as a receiver) upon initialization of the transmitter. A transmitter pseudo-random mapping order generator (PRMOG) generates a pseudo-random mapping order that is to be modified according to a predetermined pattern, such as after a symbol time. Generating pseudo-random mapping orders may eliminate the need to recalculate a channel mapping order based on changes in environmental and noise conditions, thereby decreasing a transceiver's complexity and power consumption. In addition, pseudo-random mapping orders that change according to a predetermined pattern, rather than remain static, greatly reduce the effects that changes in environmental and noise conditions have on the demodulation processes, error correction and channel capacity.

The transmitter PRMOG transmits the pseudo-random mapping order to a bit mapper, which maps bits to channels according to the pseudo-random mapping order. A modulator modulates the bits to the channels, and the transmitter transmits the bits to the receiver via a transmission medium.

A demodulator at the receiver demodulates the bits from the channels. The receiver PRMOG synchronizes with the transmitter PRMOG as a result of determining a symbol time. As a result of synchronization, the receiver PRMOG generates the pseudo-random mapping order generated by the transmitter PRMOG. The receiver PRMOG transmits the pseudo-random mapping order to a bit de-mapper, which de-maps the bits from the channels according to the pseudo-random mapping order, i.e., in the same order in which the bits were mapped to the channels. A clock transmits a clock signal to the transmitter PRMOG, establishing that the transmitter PRMOG is to generate a new pseudo-random mapping order.

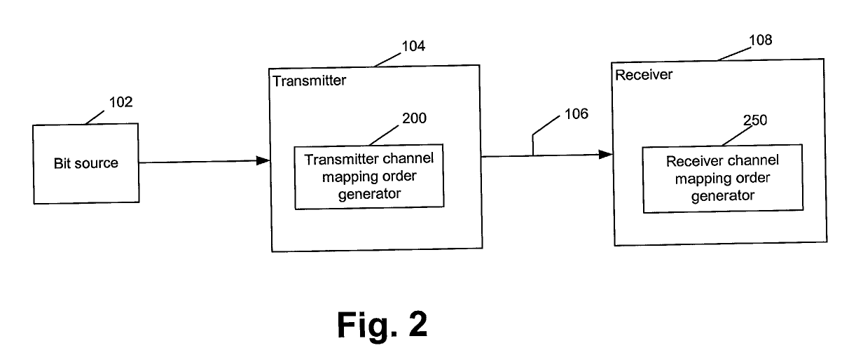

FIG. 2 is a block diagram of an example communication system within which embodiments of the present invention may be practiced. More particularly, in accordance with a first embodiment 100, bit source 102 is coupled transmitter 104, which is coupled with a receiving transceiver 108 through transmission medium 106. In accordance with an example implementation of an embodiment of the present invention, transmitter 104 is depicted comprising a transmitter channel mapping order generator 200, and receiver 108 is depicted comprising a receiver channel mapping order generator 250.

As used herein, bit source 102 provides bits that are mapped to channels in accordance with the teachings of an embodiment of the present invention. A channel (or carrier frequency) is known to those of ordinary skill in the art, and thus will not be discussed further except as it pertains to embodiments of the technique described herein. Bit source 102 is intended to represent a wide variety of devices known in the art such as, for example, an asynchronous transfer mode transmission-convergence (ATM-TC) framer, a synchronous transfer mode transmission-convergence (STM-TC) framer, a packet transfer mode transmission-convergence (PTM-TC) framer, etc. As used herein, transmission medium 106 is intended to represent a wide variety of wired and wireless transmission media known in the art such as, for example, twisted pair, coaxial cable, an antenna, etc. Because elements 102 and 106 are intended to represent any of a wide variety of such device(s) known in the art, such elements need not be further described herein.

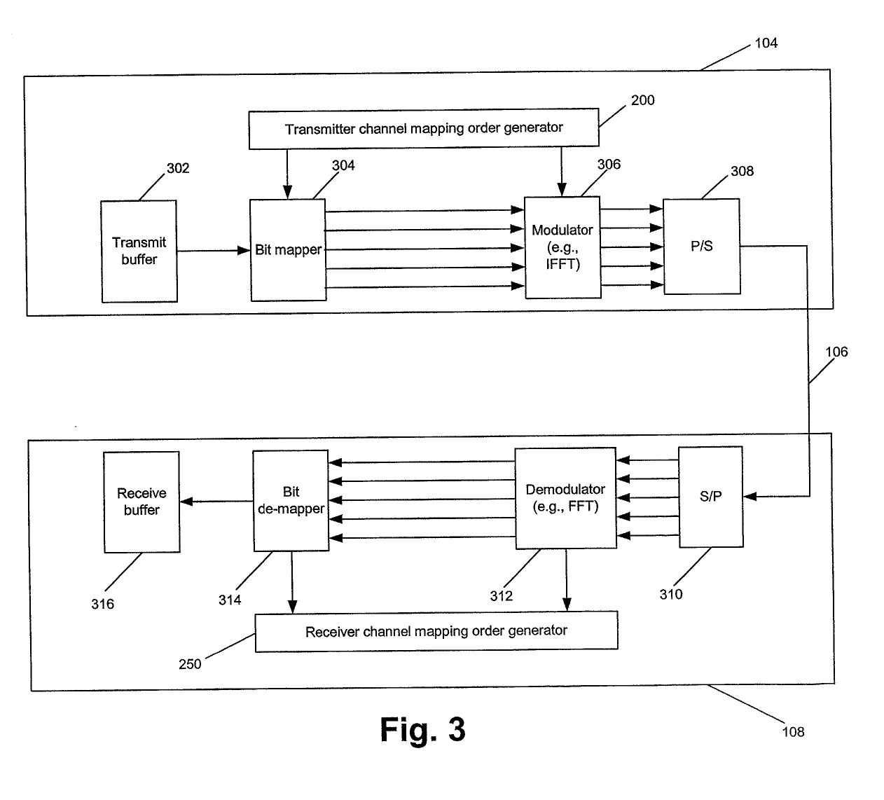

FIG. 3 is a block diagram of an example of one embodiment of transmitter 104 and receiver 108 incorporating channel mapping order generators in accordance with the teachings of an embodiment of the present invention. More particularly, in accordance with one example embodiment 300, transmitter 104 and receiver 108 comprise the following elements in addition to the elements found in a conventional transceiver.

Transmit buffer 302 contains bits that are mapped to channels in accordance with the teachings of an embodiment of the present invention. Transmit buffer 302 is intended to represent any number of devices known in the art such as, for example, an ATM-TC framer buffer, a STM-TC buffer, a PTM-TC buffer, etc. Bit mapper 304 retrieves bits from transmit buffer 302 and maps the bits to channels in accordance with a channel mapping order provided by transmitter channel mapping order generator 200. Bit mapper 304 is intended to represent any such device known in the art.

Modulator 306 modulates bits to a carrier signal. Modulator 306 is intended to represent any of a number of devices known in the art such, for example, an inverse fast Fourier transform (iFFT), a filter bank, etc. Parallel to Serial (P/S) device 308 produces one output bit at a time from a block of parallel bits output from modulator 306, for transmission via transmission medium 106. Parallel-to-serial (P/S) device 308 is intended to represent any such device known in the art. Serial-to-parallel (S/P) device 310 produces a block of parallel bits received at receiver 108 via transmission medium 106, such block of parallel bits to be input into demodulator 312. Parallel-to-serial (P/S) device 310 is intended to represent any such device known in the art.

Demodulator 312 demodulates bits from a carrier signal. Demodulator 312 is intended to represent any of a number of devices known in the art such, for example, a fast Fourier transform (FFT), a filter bank, etc. Bit de-mapper 314 de-maps the bits from channels in accordance with a pseudo-random mapping order generated by receiver channel mapping order generator 250. Bit de-mapper 314 is intended to represent any such device known in the art. Receive buffer 316 receives bits that are de-mapped from channels in accordance with the teachings of an embodiment of the present invention. Receive buffer 316 is intended to represent any number of devices known in the art such as, for example, an ATM-TC framer buffer, a STM-TC buffer, a PTM-TC buffer, etc. Because elements 302-316 are intended to represent any of a wide variety of such device(s) known in the art, such elements need not be further described herein.

As used herein, transmitter 104 and receiver 108 are intended to represent any of a number of devices known in the art such as, for example, a modem. That is, but for the integration of the pseudo-random mapping order generators described more fully below, transmitter 104 and receiver 108 are intended to represent such conventional devices as they are currently known in the art. As is known to one of ordinary skill in the art, transmitter 104 and receiver 108 may include more, fewer and/or different components than included in FIG. 3, depending upon the multicarrier transmission technique utilized. For example, in one example embodiment in which DSL is utilized, transmitter 104 includes an encoder (e.g., a Trellis encoder, a QAM encoder or constellation encoder or other encoders known in the art) and a cyclic prefix, as such device is known in the art. Similarly, receiver 108 includes a decoder (e.g., a Trellis decoder, a QAM decoder, a constellation decoder or other decoders known in the art) and a cyclic remove, as such device is known in the art. The embodiments of the invention described herein may be utilized in a wide variety of multicarrier systems, such as, for example, DSL, systems utilizing coaxial cable, wireless communication systems utilizing an antenna, etc.

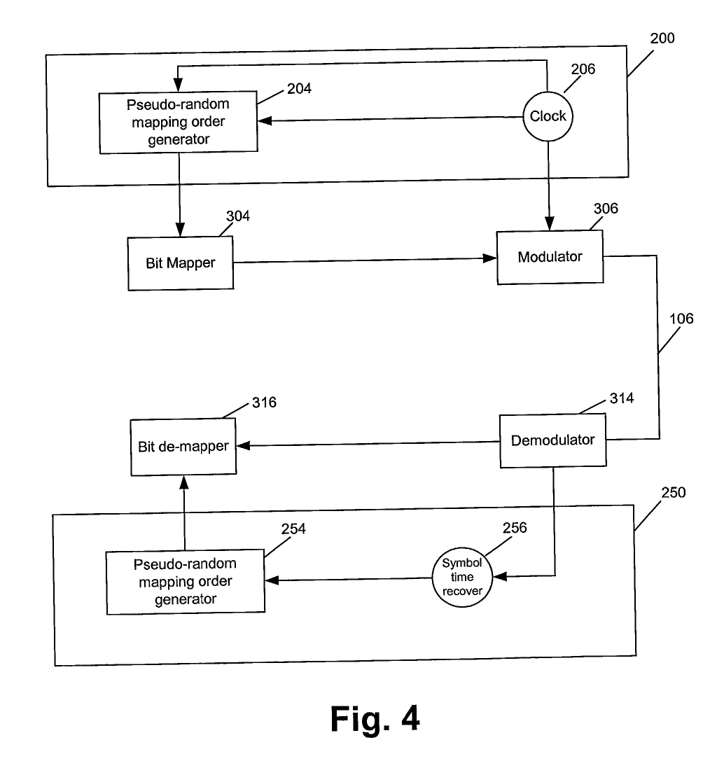

FIG. 4 is a block diagram of an example of one embodiment of pseudo-random mapping order generators in accordance with the teachings of an embodiment of the present invention. According to one example implementation, PRMOG 204 is integrated into transmitter 104, and PRMOG 254 is integrated into receiver 108. However, as is apparent to one of ordinary skill in the art, PRMOG 204 may be integrated into receiver 108 and PRMOG 254 may be integrated into transmitter 108. For purposes of illustration and ease of explanation, the embodiments of the invention described herein will be described in terms of PRMOG 204 integrated into transmitter 104 and PRMOG 254 integrated into receiver 108.

FIG. 4 depicts transmitter channel mapping order generator 200 comprising a PRMOG 204 and a clock 206, each coupled as depicted. Although depicted as a number of disparate functional items, those skilled in the art will appreciate that one or more of such elements may well be combined into single functional entities. Alternatively, certain elements may be split into multiple functional elements.

As used herein, PRMOG 204 generates a pseudo-random mapping order that is input to bit mapper 304, which maps bits to channels according to the pseudo-random mapping order. Furthermore, PRMOG 204 modifies the pseudo-random mapping order according to a predetermined pattern established pursuant to clock 206. In one embodiment, the predetermined pattern is a symbol time. In an alternative embodiment, the predetermined pattern is an alternating symbol time. As is known to those of ordinary skill in the art, a symbol is generated when a transmitter maps all channels with bits, and a symbol time is the time required to transmit a symbol to a receiver. PRMOG 204 is intended to represent a wide variety of devices known in the art. For example, according to one example implementation, PRMOG 204 is a pseudo-noise sequence generator known in the art.

A pseudo-random mapping order is deemed “pseudo-random” because it is an ordering that appears to be random, but is actually generated in an algorithmically defined manner. For example, according to one example implementation, PRMOG 204 generates a pseudo-random mapping order according to an algorithm, wherein such algorithm is any algorithm known in the art (e.g., the Berlekamp-Massey algorithm, the Reed-Sloane Algorithm).

As used herein, clock 206 provides a clock signal to PRMOG 204 that establishes when to generate a new pseudo-random mapping order. Clock 206 is intended to represent a wide variety of devices known in the art. For example, according to one example implementation, clock 206 is a symbol clock.

FIG. 4 depicts receiver channel mapping order generator 250 comprising a PRMOG 254 and symbol time recover 256, each coupled as depicted. Although depicted as a number of disparate functional items, those skilled in the art will appreciate that one or more of such elements may well be combined into single functional entities. Alternatively, certain elements may be split into multiple functional elements.

As used herein, PRMOG 254 generates a pseudo-random mapping order in accordance with PRMOG 204 as a result of synchronizing with PRMOG 204, and thus modifies the pseudo-random mapping order according to a predetermined pattern in accordance with PRMOG 204. The pseudo-random mapping order generated by PRMOG is input to bit de-mapper 314, which de-maps bits from channels according to the pseudo-random mapping order. PRMOG 254 is intended to represent a wide variety of devices known in the art. For example, according to one example implementation, PRMOG 254 is a pseudo-noise sequence generator known in the art.

As used herein, symbol time recover 256 determines a symbol time of a transmission from transmitter 104. In one embodiment, determining the symbol time enables PRMOG 254 to synchronize with PRMOG 204, because determining a symbol time leads to determining a symbol, which results in being able to determine a pseudo-random mapping order generated by PRMOG 204. Symbol time recover 256 is intended to represent a wide variety of devices known in the art.

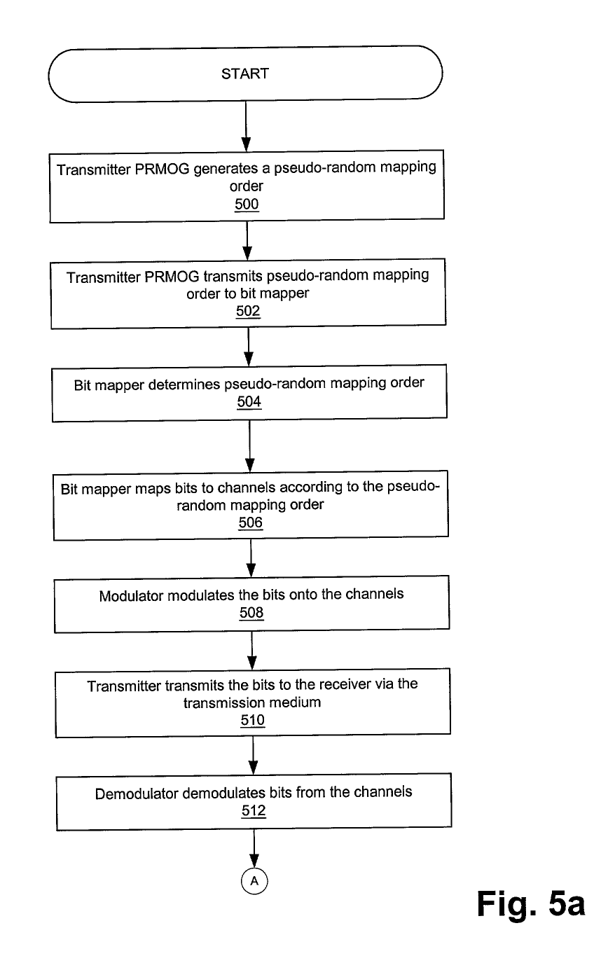

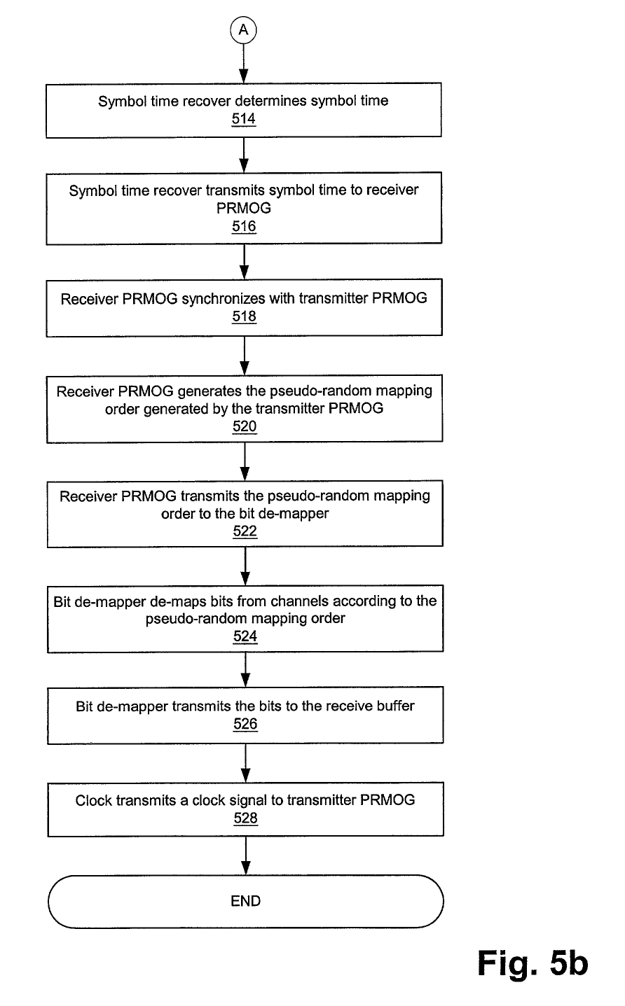

FIG. 5a and FIG. 5b are a flow chart of an example method of transmitting data according to a pseudo-random mapping order, in accordance with one aspect of an embodiment of the present invention.

At block 500, PRMOG 204 generates a pseudo-random mapping order and at block 502 transmits it to bit mapper 304. At block 504, bit mapper 304 determines the pseudo-random mapping order, and at block 506 retrieves bits from transmit buffer 302 and maps the bits to channels according to the pseudo-random mapping order. At block 508, modulator 306 modulates the bits onto the channels, and at block 510, transmitter 104 transmits the bits to receiver 108 via transmission medium 106. In one embodiment, transmitter 104 transmits the bits after each symbol.

At block 512, demodulator 312 demodulates the bits from the channels. At block 514, symbol time recover 256 determines the symbol time of the bits transmitted from transmitter 104 to receiver 108, and at block 516 transmits the symbol time to PRMOG 254. At block 518, PRMOG 254 synchronizes with PRMOG 204 as a result of receiving the symbol time from symbol time recover 256. In an alternative embodiment, PRMOG 254 synchronizes with PRMOG 204 as a result of receiving a dedicated synchronization signal from PRMOG 204.

At block 520, PRMOG 254 generates the pseudo-random mapping order generated by PRMOG 204. At block 522, PRMOG 254 transmits the pseudo-random mapping order to bit de-mapper 314. At block 524, bit de-mapper 314 de-maps the bits from the channels according to the pseudo-random mapping order. That is, bit de-mapper 314 de-maps the bits from the channels in the order in which mapper 304 mapped the bits to the channels. At block 526, bit de-mapper 314 transmits the bits to receive buffer 316.

At block 528, clock 202 transmits a clock signal to PRMOG 204 establishing that PRMOG 204 is to generate a new pseudo-random mapping order. According to one example implementation, clock 202 establishes that PRMOG 204 is to generate a new channel mapping after each symbol time. According to alternative example embodiments, clock 202 may establish that PRMOG 204 is to generate a new pseudo-random mapping order after alternate symbol times, after any number of symbol times, or after an elapse of a specified period of time.

Reference in the foregoing specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. An apparatus comprising:
a pseudo-random mapping order generator to generate a pseudo-random mapping order to be modified according to a predetermined pattern; and
a bit mapper, to map bits to channels according to the pseudo-random mapping order.

2. The apparatus of claim 1, further comprising a modulator, coupled with the bit mapper, to modulate the bits to the channels.

3. The apparatus of claim 1, further comprising a clock, coupled with the pseudo-random mapping order generator, to establish the predetermined pattern.

4. The apparatus of claim 3, wherein the clock comprises a symbol clock.

5. The apparatus of claim 4, wherein the predetermined pattern comprises a symbol time.

6. The apparatus of claim 4, wherein the predetermined pattern comprises an alternating symbol time.

7. The apparatus of claim 1, further comprising a transmit buffer, coupled with the bit mapper, to hold the bits received from a bit source.

8. An apparatus comprising:
a pseudo-random mapping order generator to synchronize with an external pseudo-random mapping order generator; and
a bit de-mapper, to de-map bits from channels according to a pseudo-random mapping order generated by the external pseudo-random mapping order generator, the pseudo-random mapping order to be modified according to a predetermined pattern.

9. The apparatus of claim 8, wherein the pseudo-random mapping order generator synchronizes with the external pseudo-random mapping order generator based at least in part on a symbol time of the bits.

10. The apparatus of claim 9, further comprising a symbol time recover, coupled with the pseudo-random mapping order generator, to determine the symbol time.

11. The apparatus of claim 8, further comprising a demodulator, coupled with the bit de-mapper, to demodulate the bits from the channels.

12. The apparatus of claim 8, further comprising a receive buffer, coupled with the bit de-mapper, to receiver the bits from the de-mapper.

13. A digital signal transceiver, comprising:
a channel order generator to generate a pseudo-random carrier frequency ordering to be used to transmit bits of data, the ordering to be modified according to a predetermined pattern; and
a bit mapper, coupled with the channel order generator, to map one or more bits of data to the carrier frequencies using the ordering.

14. The digital signal transceiver of claim 13, further comprising a clock, coupled with the channel order generator, to establish the predetermined pattern.

15. The digital signal transceiver of claim 14, wherein the clock comprises a symbol clock.

16. The digital signal transceiver of claim 15, wherein the predetermined pattern comprises a symbol time.

17. The digital signal transceiver of claim 15, wherein the predetermined pattern comprises an alternating symbol time.

18. A method comprising:
generating a pseudo-random mapping order that is to be modified according to a predetermined pattern;
mapping bits to channels according to the pseudo-random mapping order;
transmitting received bits; and
generating a different pseudo-random mapping order according to the predetermined pattern.

19. The method of claim 18, wherein the predetermined pattern comprises a symbol time.

20. The method of claim 18, wherein the predetermined pattern comprises an alternating symbol time.

21. A method comprising:
synchronizing with a remote pseudo-random mapping order generator that has generated a pseudo-random mapping order that is to be modified according to a predetermined pattern; and
de-mappping bits from channels according to the pseudo-random mapping order.

22. The method of claim 21, wherein synchronizing with a remote pseudo-random mapping order generator comprises determining a symbol time of the bits.

23. The method of claim 21, wherein the predetermined pattern comprises a symbol time.

24. A system comprising:
a bit source to provide bits to a transmitter;
the transmitter, coupled with the bit source, to generate a pseudo-random mapping order to be modified according to a predetermined pattern, map the bits to channels according to the pseudo-random mapping order, and transmit the bits to a receiver via a transmission medium;
the transmission medium, coupled with the transmitter, via which the bits are transmitted; and
the receiver, coupled with the transmission medium, to receive the bits and de-map the bits from the channels according to the pseudo-random mapping order.

25. The system of claim 24, wherein the transmission medium comprises twisted pair.

26. The system of claim 24, wherein the transmission medium comprises coaxial cable.

27. The system of claim 24, wherein the transmission medium comprises an antenna.

28. The system of claim 24, wherein the bit source comprises an asynchronous transfer mode transmission compression framer.

29. The system of claim 24, wherein the bit source comprises a synchronous transfer mode transmission compression framer.

30. The system of claim 24, wherein the bit source comprises a packet transfer mode transmission compression framer.

31. The system of claim 24, wherein the predetermined pattern comprises a symbol time.

32. The system of claim 24, wherein the predetermined pattern comprises an alternating symbol time.
